(19) United States
(12) Patent Application Publication
(10) Pub. No.: US 2025/0175243 A1
(43) Pub. Date: May 29, 2025

(54) RELAY SWITCHING AND MOBILE HANDOVERS FOR RELAY AIRCRAFTS

(71) Applicant: QUALCOMM Incorporated, San Diego, CA (US)

(72) Inventors: Mingxi YIN, Beijing (CN); Kangqi LIU, San Diego, CA (US); Chao WEI, Beijing (CN); Ruiming ZHENG, Beijing (CN); Qiaoyu LI, Beijing (CN); Hao XU, Beijing (CN)

(21) Appl. No.: 18/836,319

(22) PCT Filed: Apr. 12, 2022
(86) PCT No.: PCT/CN2022/086294

§ 371 Date: Aug. 6, 2024

(51) Int. Cl. H04B 7/185; H04W 88/04

(52) U.S. Cl. CPC H04B 7/18513; H04W 88/04

(57) ABSTRACT

Disclosed are systems and techniques for performing wireless communication. In some aspects, an aircraft user equipment (UE) may transmit a first location corresponding to a terrestrial UE and a second location corresponding to a network entity, wherein the aircraft UE is configured to relay data between the terrestrial UE and the network entity. In some examples, the aircraft UE may receive, from one or more candidate aircraft UEs, at least one timing parameter corresponding to a relay area that is based on the first location and the second location. In some cases, the aircraft UE may select, based on the at least one timing parameter, a target aircraft UE from the one or more candidate aircraft UEs for relaying data between the terrestrial UE and the network entity.

### CROSS-REFERENCE TO RELATED APPLICATIONS

This application for Patent is a 371 of international Patent Application PCT/CN2022/086294, filed Apr. 12, 2022, which is hereby incorporated by referenced in its entirety and for all purposes.

### FIELD OF THE DISCLOSURE

Aspects of the present disclosure generally relate to wireless communication. In some implementations, examples are described for performing wireless communications using air-to-ground connections.

### BACKGROUND OF THE DISCLOSURE

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

Air-to-ground (ATG) communications systems are deployed to provide various telecommunication services associated with aircrafts. ATG communications systems can be implemented to interface with terrestrial wireless communications systems by positioning terrestrial antennas (e.g., at a base station) in a manner that can communicate with aircraft antennas while the aircraft is in flight. In some cases, ATG communications can be used to provide in-flight communication services for airborne devices. In addition, ATG communications can be used to provide airline operations communications (e.g., aircraft maintenance, flight planning, weather, etc.) as well as air traffic control information.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one example, a method for wireless communications performed at an aircraft user equipment (UE) is provided. The method may include: transmitting a first location corresponding to a terrestrial UE and a second location corresponding to a network entity, wherein the aircraft UE is configured to relay data between the terrestrial UE and the network entity; receiving, from one or more candidate aircraft UEs, at least one timing parameter corresponding to a relay area that is based on the first location and the second location; and selecting, based on the at least one timing parameter, a target aircraft UE from the one or more candidate aircraft UEs for relaying data between the terrestrial UE and the network entity.

In another example, an apparatus for wireless communications is provided that includes at least one memory comprising instructions and at least one processor (e.g., configured in circuitry) configured to execute the instructions and cause the apparatus to: transmit a first location corresponding to a terrestrial UE and a second location corresponding to a network entity, wherein the apparatus is configured to relay data between the terrestrial UE and the network entity; receive, from one or more candidate aircraft UEs, at least one timing parameter corresponding to a relay area that is based on the first location and the second location; and select, based on the at least one timing parameter, a target aircraft UE from the one or more candidate aircraft UEs for relaying data between the terrestrial UE and the network entity.

In another example, a non-transitory computer-readable medium is provided that includes stored thereon at least one instruction that, when executed by one or more processors, may cause the one or more processors to: send, by an aircraft user equipment (UE), a first location corresponding to a terrestrial UE and a second location corresponding to a network entity, wherein the aircraft UE is configured to relay data between the terrestrial UE and the network entity; receive, from one or more candidate aircraft UEs, at least one timing parameter corresponding to a relay area that is based on the first location and the second location; and select, based on the at least one timing parameter, a target aircraft UE from the one or more candidate aircraft UEs for relaying data between the terrestrial UE and the network entity.

In another example, an apparatus for wireless communication is provided. The apparatus may include: means for transmitting a first location corresponding to a terrestrial UE and a second location corresponding to a network entity, wherein the apparatus is configured to relay data between the terrestrial UE and the network entity; means for receiving, from one or more candidate aircraft UEs, at least one timing parameter corresponding to a relay area that is based on the first location and the second location; and means for selecting, based on the at least one timing parameter, a target aircraft UE from the one or more candidate aircraft UEs for relaying data between the terrestrial UE and the network entity.

In another example, a method for wireless communications performed at a first aircraft user equipment (UE) is provided. The method may include: receiving, from a second aircraft UE, a first location corresponding to a terrestrial UE and a second location corresponding to a network entity; determining at least one timing parameter corresponding to a relay area that is based on the first location and the second location; and transmitting the at least one timing parameter to the second aircraft UE.

In another example, an apparatus for wireless communications is provided that includes at least one memory comprising instructions and at least one processor (e.g., configured in circuitry) configured to execute the instructions and cause the apparatus to: receive, from an aircraft UE, a first location corresponding to a terrestrial UE and a second location corresponding to a network entity; determine at least one timing parameter corresponding to a relay area that is based on the first location and the second location; and transmit the at least one timing parameter to the aircraft UE.

In another example, a non-transitory computer-readable medium is provided that includes stored thereon at least one instruction that, when executed by one or more processors, may cause the one or more processors to: receive, from an aircraft UE, a first location corresponding to a terrestrial UE and a second location corresponding to a network entity; determine at least one timing parameter corresponding to a relay area that is based on the first location and the second location; and send the at least one timing parameter to the aircraft UE.

In another example, an apparatus for wireless communication is provided. The apparatus may include: means for receiving, from an aircraft user equipment (UE), a first location corresponding to a terrestrial UE and a second location corresponding to a network entity; means for determining at least one timing parameter corresponding to a relay area that is based on the first location and the second location; and means for transmitting the at least one timing parameter to the aircraft UE.

In another example, a method for wireless communications performed by an aircraft user equipment (UE) is provided. The method may include: identifying, by the aircraft UE, one or more candidate network entities for performing a conditioned handover from a serving network entity, wherein the aircraft UE is configured to relay data between a terrestrial UE and the serving network entity; and initiating, based on a handover trigger, the conditioned handover from the serving network entity to a target network entity selected from the one or more candidate network entities.

In another example, an apparatus for wireless communications is provided that includes at least one memory, at least one transceiver, and at least one processor (e.g., configured in circuitry) communicatively coupled to the at least one memory and the at least one transceiver. The at least one processor may be configured to: identify one or more candidate network entities for performing a conditioned handover from a serving network entity, wherein the apparatus is configured to relay data between a terrestrial UE and the serving network entity; and initiate, based on a handover trigger, the conditioned handover from the serving network entity to a target network entity selected from the one or more candidate network entities.

In another example, a non-transitory computer-readable medium of a wireless communication device is provided that includes stored thereon at least one instruction that, when executed by one or more processors, may cause the one or more processors to: identify, by an aircraft user equipment (UE), one or more candidate network entities for performing a conditioned handover from a serving network entity, wherein the aircraft UE is configured to relay data between a terrestrial UE and the serving network entity; and initiate, based on a handover trigger, the conditioned handover from the serving network entity to a target network entity selected from the one or more candidate network entities.

In another example, an apparatus for wireless communication is provided. The apparatus may include: means for identifying, by the apparatus, one or more candidate network entities for performing a conditioned handover from a serving network entity, wherein the apparatus is configured to relay data between a terrestrial UE and the serving network entity; and means for initiating, based on a handover trigger, the conditioned handover from the serving network entity to a target network entity selected from the one or more candidate network entities.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a diagram illustrating an example wireless communications system for performing relay switching and mobile handovers for relay aircrafts, in accordance with some examples;

FIG. 6 is a diagram illustrating an example wireless communications system for performing relay switching for relay aircrafts, in accordance with some examples;

FIG. 7 is a diagram illustrating an example wireless communications system for performing mobile handovers for relay aircrafts, in accordance with some examples;

FIG. 8 is a sequence diagram illustrating an example of a sequence for performing relay switching for relay aircrafts, in accordance with some examples;

FIG. 9 is a flow diagram illustrating an example of a process implemented by an aircraft UE for performing relay switching, in accordance with some examples;

FIG. 10 is a flow diagram illustrating another example of a process implemented by an aircraft UE for performing relay switching, in accordance with some examples;

FIG. 11 is a flow diagram illustrating an example of a process implemented by an aircraft UE for performing mobile handovers, in accordance with some examples; and

FIG. 12 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks are deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In some cases, a client device may be outside of the coverage area associated with a wireless communication network. For example, a client device may be located in a geographical area that is outside the range of the nearest base station or in a geographical area with poor signal quality. In such cases, access to a wireless communication network may be possible by using satellite communications. However, communication with existing satellite systems (e.g., Iridium® satellites) is not practical. For example, communication with existing satellite systems may require the use of specialized client devices that satisfy strict antenna and transmit power requirements. In some cases, use of such specialized client devices requires skillful human-assisted operation for antenna positioning in a manner that avoids interference. While the shortcomings of existing satellite systems may be addressed by 3GPP non-terrestrial networks (NTN), such networks are associated with very high deployment costs (e.g., launching of new satellites), which may delay or hinder implementation.

Air-to-ground (ATG) communications can be used to provide connectivity between terrestrial wireless communication networks and aircrafts. As used herein, an aircraft can include any apparatus or device that is configured to or able to fly through the air, such as an airplane (e.g., commercial airplanes, private airplanes, turboprop aircrafts, piston aircrafts, jets, military aircrafts, etc.), an unmanned aerial vehicle (UAE) or drone, a helicopter, an airship (e.g., a blimp or other airship), a glider, or other apparatus or device that is configured to or able to fly. For example, ATG communications can be implemented by positioning an antenna on a base station in an upward direction (e.g., antenna up-tilting) to facilitate communication with an airborne aircraft having an antenna on the bottom and/or side. ATG communications can be used to provide in-flight passenger communication services, airline operation communications, and air traffic control services, among others. Advantages of ATG communications over satellite communications include lower cost, higher throughput, and lower latency.

In some cases, an aircraft can be configured as an aircraft relay that can relay data between a user equipment (UE) and a network entity (e.g., a base station). However, in some examples, the aircraft may only server as an aircraft relay for a short time due to the speed of flight of the aircraft through a relay area in which the aircraft is able to communicate with the UE and the base station (e.g., intersection between the flight route and coverage areas of the UE and/or the base station). In one illustrative example, an aircraft travelling at a speed of 250 meters (m)/second (s) through a circular relay area having a radius of 50 km would serve as an aircraft relay for 400 s. In some cases, the limited time that an aircraft may perform as an aircraft relay may not be sufficient (e.g., a UE may not receive feedback to an SOS message).

Systems, apparatuses, processes (also referred to as methods), and computer-readable media (collectively referred to as “systems and techniques”) are described herein for performing relay aircraft switching and conditional handovers (CHOs)) for relay aircrafts. The systems and techniques provide the ability for an aircraft relay to select and configure a target aircraft to continue aircraft relaying. The systems and techniques also provide the ability for an aircraft relay to perform a CHO by selecting and configuring communications with a target base station.

In some aspects, relay aircraft switching can be used to extend data relaying time between a user equipment (UE) and a network entity such as a base station. In some cases, relay aircraft switching can be used to avoid message loss by configuring a start time for a target aircraft relay to continue data relaying between the UE and the base station. In some examples, a CHO can be used to avoid message loss by communicating with a target base station to continue communications between the UE and the network (e.g., via the target base station).

In some examples, an aircraft can be configured to relay data between a UE and a base station while the aircraft is within a relay area. In some cases, the relay area can correspond to a geographic area in which the aircraft can communicate with the UE and the base station. For instance, the relay area can be based on the location and the signal range of the UE and base station. In some aspects, the current relay aircraft may transmit the location of the UE and the location of the base station to one or more candidate relay aircrafts. Based on the location data, the one or more candidate relay aircrafts may determine one or more time metrics corresponding to the relay area. For example, the candidate relay aircrafts may determine a time to enter the relay area, a time to exit the relay area, a time duration within the relay area, etc. (e.g., using planned aircraft flight routes or trajectories). Based on these parameters, the current relay aircraft can select a target relay aircraft from the one or more candidate relay aircrafts. For instance, the current relay aircraft may select the target relay aircraft that will be first to enter the relay area. In another example, the current relay aircraft may select the target relay aircraft that will be last to exit the relay area. In another example, the current relay aircraft may select the target relay aircraft that will stay in the relay area the longest amount of time.

In some aspects, a current relay aircraft may determine that the current relay aircraft is exiting a coverage area associated with the base station while remaining within a coverage area associated with the UE. In some examples, the current relay aircraft may then initiate a CHO to continue relaying data between the UE and a target base station selected from among one or more candidate base stations. In some cases, the CHO may be triggered based on a handover trigger (e.g., a location trigger, an reference signal received power (RSRP) trigger, a time trigger, and/or any other suitable trigger parameter). For example, a location trigger for CHO may be based on a distance between the current relay aircraft and the serving cell. In another example, a location trigger for CHO may be based on a distance between the current relay aircraft and one or more candidate target cells. In another example, an RSRP trigger for CHO may be based on the RSRP associated with the serving cell and/or the RSRP associated with one or more of the candidate target cells. In another example, a time trigger for CHO may be based on a timer or the Universal Time Coordinated (UTC) or a time range based on the aircraft trajectories and/or speed.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAE) or drone, helicopter, airship, glider, etc.) and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal. In some aspects, an apparatus (e.g., network entity, base station, UE, wireless device, etc.) implementing the systems and techniques described herein may receive (e.g., obtain, collect, get, acquire, etc.) information or data in addition to or as an alternative to receiving an RF signal. In some cases, an apparatus (e.g., network entity, base station, UE, wireless device, etc.) implementing the systems and techniques described herein may transmit (e.g., output, transfer, send, communicate, convey, etc.) information or data in addition to or as an alternative to transmitting an RF signal.

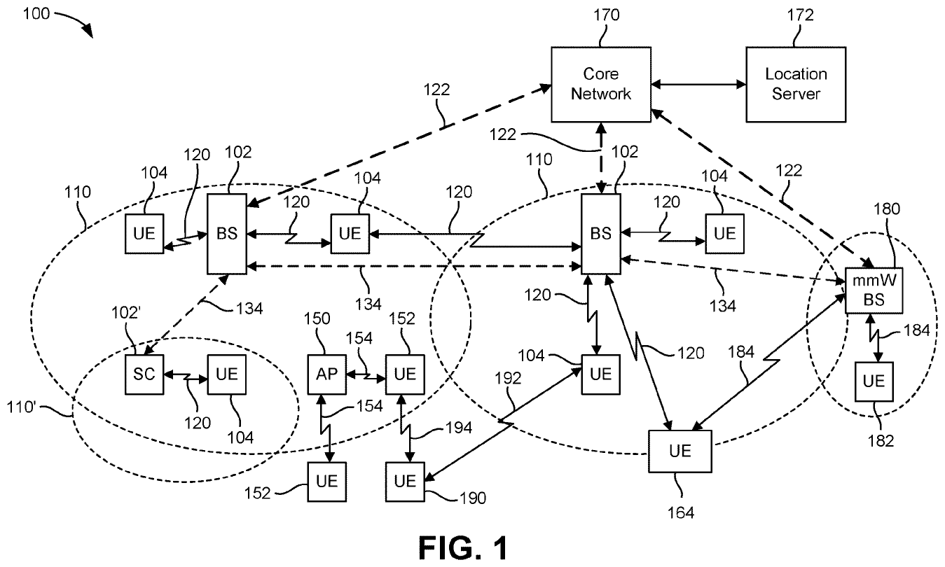

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

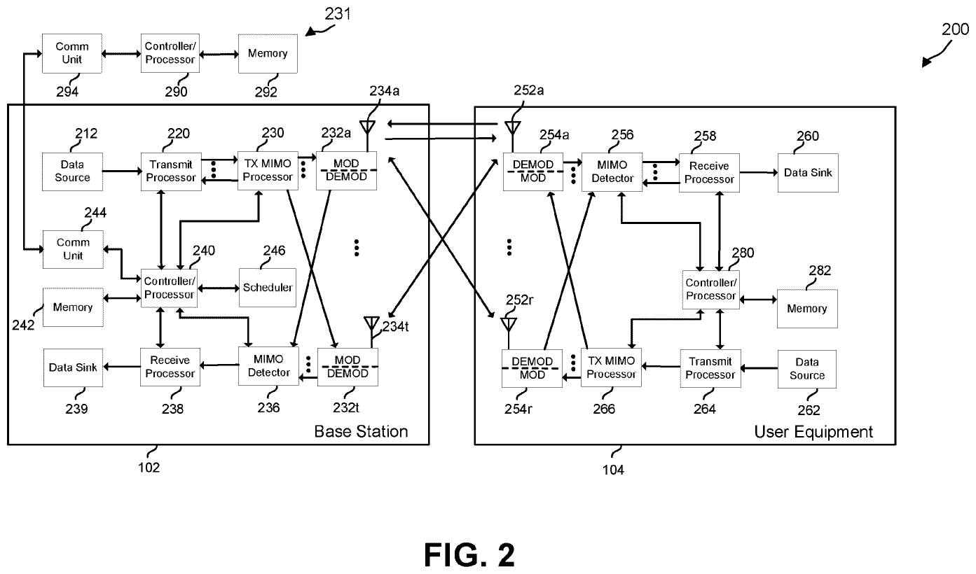

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

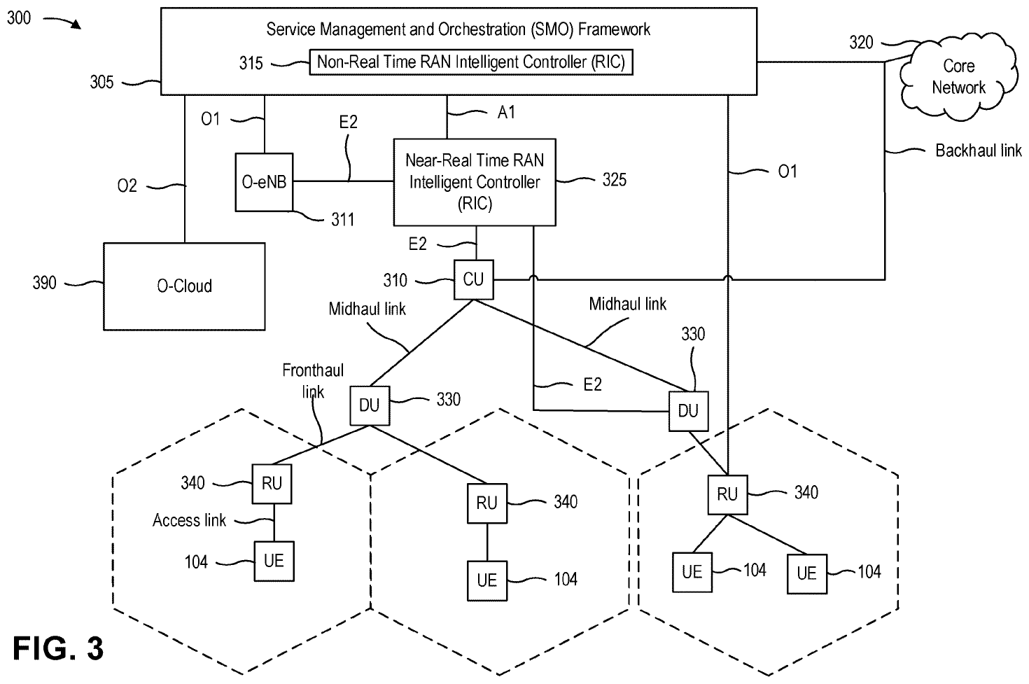

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

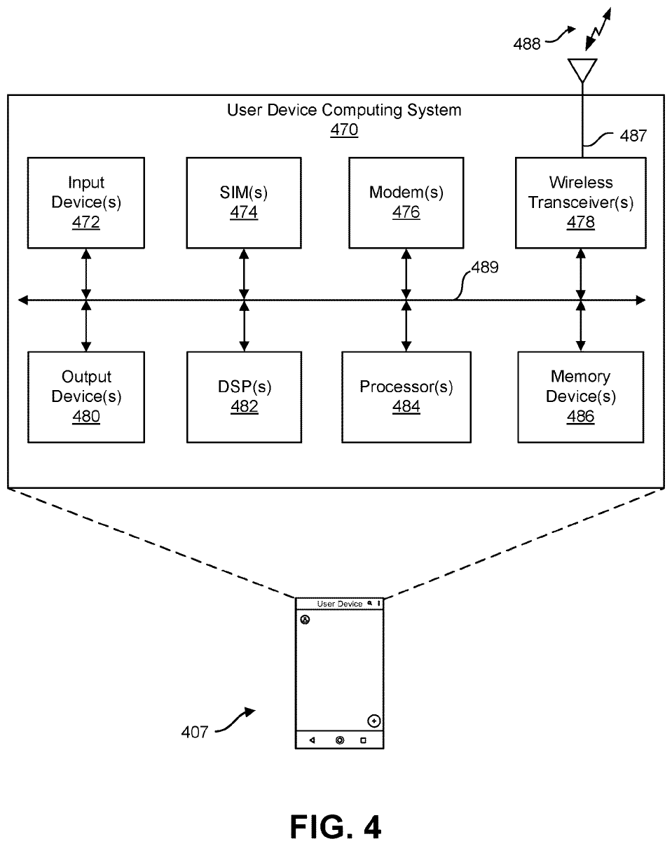

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

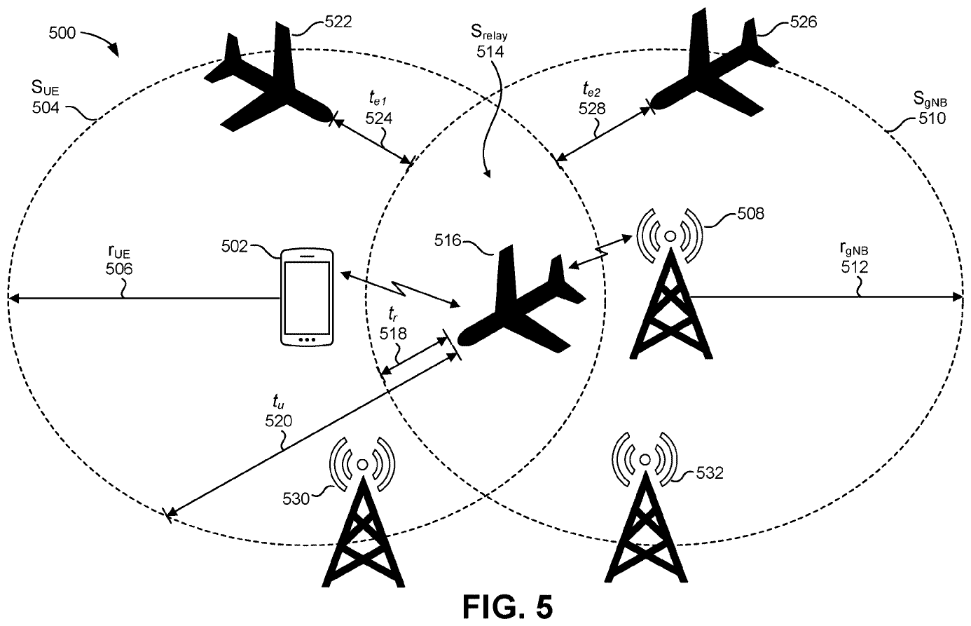

As noted previously, systems and techniques are described herein for performing relay switching and mobile handovers for relay aircrafts. FIG. 5 is a diagram illustrating an example wireless communications system 500 for performing relay aircraft switching and mobile handovers (e.g., conditional handovers (CHOs)) for relay aircrafts. While the system 500 is described using user equipment (UE) and base stations (BSs) as illustrative examples, the techniques described with respect to system 500 can be performed by Wi-Fi stations (STA), access points (APs), components of disaggregated base station, or by other devices that communicate using other communication protocols.

In some examples, system 500 can include one or more user equipment (UE) devices, such as UE 502. As noted with respect to FIG. 1, a UE (e.g., UEs 104) may include and/or be referred to as an access terminal, a user device, a user terminal, a client device, a wireless device, a subscriber device, a subscriber terminal, a subscriber station, a mobile device, a mobile terminal, a mobile station, or variations thereof. In some aspects, a UE can include a mobile telephone or so-called “smart phone”, a tablet computer, a wearable device, an extended reality device (e.g., a virtual reality (VR) device, an augmented reality (AR) device, or a mixed reality (MR) device), a personal computer, a laptop computer, an internet of things (IoT) device, a television, a vehicle (or a computing device of a vehicle), or any other device having a radio frequency (RF) interface.

In some cases, system 500 can include one or more aircraft UEs such as aircraft 516, aircraft 522, and aircraft 526. In some examples, aircraft 516, aircraft 522, and/or aircraft 526 may correspond to an airplane, a jet, an unmanned aerial vehicle (UAE), a drone, a helicopter, an airship, a glider, etc.

In some examples, system 500 can include one or more base stations such as base station 508, base station 530, and base station 532. In some cases, base stations 508, 530, and/or 532 can include macro cell base stations and/or small cell base stations, as described in connection with system 100 (e.g., base stations 102). In other aspects, base stations 508, 530, and/or 532 can include a wireless access point, such as, for example, AP 150 described in connection with system 100. In some configurations, base stations 508, 530, and/or 532 can correspond to components of a disaggregated base station, such as, for example, CU 310, DU 330, and/or RU 340, as described in connection with system 300.

In some aspects, each base station can be associated with a respective geographic coverage area. For instance, base station 508 can be associated with coverage area S_{gNB} 510. In some examples, coverage area S_{gNB} 510 may correspond to a sphere having a radius r_{gNB} 512. In some cases, coverage area S_{gNB} 510 may correspond to any other shape such as an ellipsoid, cube, cuboid, cylinder, polyhedron, etc. In some instances, radius r_{gNB} 512 may correspond to a signal range of base station 508 that may be measured or determined based on a maximum pathloss and/or a minimum reference signal received power (RSRP). In some examples, r_{gNB} 512 can be determined using the Friis transmission formula. In some examples, r_{gNB} 512 can be determined using pathloss models, such as those proposed in 3GPP TR 38.901, hereby incorporated by reference in its entirety and for all purposes.

In some cases, UE 502 can also be associated with a respective geographic coverage area (e.g., signal range). For example, UE 502 can be associated with coverage area S_{UE} 504. In some aspects, coverage area S_{UE} 504 may correspond to a sphere having a radius r_{UE} 506. In some examples, coverage area S_{UE} 504 may correspond to any other shape such as an ellipsoid, cube, cuboid, cylinder, polyhedron, etc. In some instances, radius r_{UE} 506 may correspond to a signal range of UE 502 that may be measured or determined based on a maximum pathloss and/or a minimum reference signal received power (RSRP). In some examples, r_{UE} 506 can be determined using the Friis transmission formula. In some examples, r_{UE} 506 can be determined using pathloss models, such as those proposed in 3GPP TR 38.901.

In some examples, aircraft 516 may be configured to relay data (e.g., uplink and/or downlink signals) between UE 502 and base station 508. In some cases, aircraft 516 may perform data relaying between UE 502 and base station 508 when aircraft 516 is within a relay area (e.g., a geographic area corresponding to coverage area S_{gNB} 510 and/or coverage area S_{UE} 504). In some aspects, the relay area may correspond to S_{relay} 514. In some configurations, S_{relay} 514 can correspond to a geographic area in which aircraft 516 is within coverage area S_{gNB} 510 and coverage area S_{UE} 504. In one illustrative example, S_{relay} 514 can be denoted as the intersection of S_{gNB} 510 and S_{UE} 504 (e.g., S_{relay} 514=S_{gNB} 510∩S_{UE} 504).

In some instances, aircrafts 516, 522, and/or 526 may determine or receive data corresponding to the signal range of base station 508 (e.g., radius r_{gNB} 512) and/or the signal range of UE 502 (e.g., r_{UE} 506). In some cases, aircrafts 516, 522, and/or 526 may determine the coverage area of base station 508 (e.g., S_{gNB} 510) based on location data associated with base station 508 and the signal range of base station 508 (e.g., r_{gNB} 512). In some aspects, aircrafts 516, 522, and/or 526 may determine the coverage area of UE 502 (e.g., S_{UE} 504) based on location data associated with UE 502 and the signal range of UE 502 (e.g., r_{UE} 506). In some examples, aircrafts 516, 522, and/or 526 may determine a relay area (e.g., S_{relay} 514) for relaying data between UE 502 and base station 508 based on the coverage area of UE 502 (e.g., S_{gNB} 510) and the coverage area of base station 508 (e.g., S_{gNB} 510). In some cases, the coverage area of UE 502 (e.g., S_{UE} 504) and the relay area (e.g., S_{relay} 514) can be dynamically updated based on movement of UE 502.

In some examples, aircrafts 516, 522, and/or 526 can calculate one or more timing parameters based on aircraft flight parameters (e.g., speed, heading, route, altitude, etc.) and coverage area S_{UE} 504, coverage area S_{gNB} 510, and relay area S_{relay} 514. For example, aircraft 516 can determine a time remaining (e.g., time tᵣ 518) for aircraft 516 to exit relay area S_{relay} 514. In another example, aircraft 516 can determine a time remaining (e.g., time tᵤ 520) for aircraft 516 to exit the coverage area of UE 502 (e.g., S_{UE} 504). In some aspects, aircraft 522 may determine a time remaining (e.g., time tₑ₁ 525) for aircraft 522 to enter relay area S_{relay} 514. In some cases, aircraft 526 may determine a time remaining (e.g., time tₑ₂ 528) for aircraft 526 to enter relay area S_{relay} 514.

In some aspects, aircraft 516 can be configured to perform relay aircraft switching by selecting and/or configuring a different aircraft to perform data relaying between UE 502 and base station 508. In some cases, relay aircraft switching can be performed in anticipation of the current relay aircraft (e.g., aircraft 516) leaving the coverage area of UE 502 (e.g., coverage area S_{UE} 504), the coverage area of base station 508 (e.g., coverage area S_{gNB} 510) and/or the relay area (e.g., S_{relay} 514). In some aspects, aircraft 516 can perform relay aircraft switching based on the time remaining for aircraft 516 to exit relay area S_{relay} 514 (e.g., time tᵣ 518) and/or the time remaining for aircraft 516 to exit the coverage area S_{UE} 504 of UE 502 (e.g., time tᵤ 520). In some examples, aircraft 516 can perform relay aircraft switching when tᵣ>αtᵤ, in which α can correspond to a ratio factor having a value from 0 to 1.

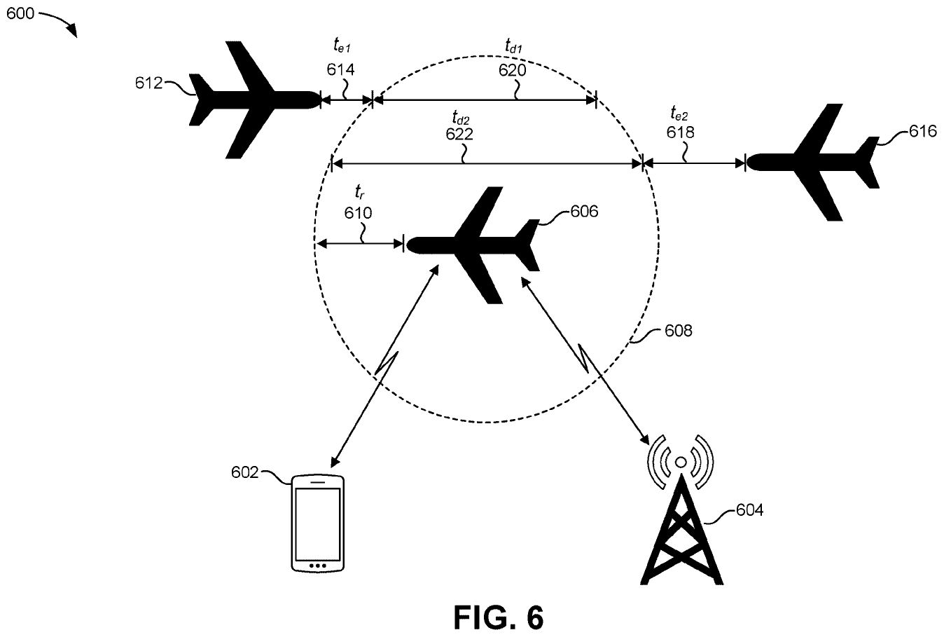

In some examples, aircraft 516 can communicate with one or more candidate aircrafts (e.g., aircraft 522 and/or aircraft 526) to select and/or configure a respective candidate aircraft to perform data relaying between UE 502 and base station 508. In some cases, aircraft 516 may select a candidate aircraft for relay aircraft switching based on one or more timing parameters. For example, aircraft 516 may select aircraft 522 to perform data relaying between UE 502 and base station 508 when tₑ₁ 524 is less than tₑ₂ 528 (e.g., aircraft 522 will enter relay area S_{relay} 514 before aircraft 526). Further details regarding relay aircraft switching are discussed in connection with FIG. 6.

In some examples, aircraft 516 can be configured to perform a conditioned handover (CHO) for UE 502. In some aspects, a CHO can be performed in anticipation of the current relay aircraft (e.g., aircraft 516) leaving the coverage area of base station 508 (e.g., S_{gNB} 510). In some aspects, aircraft 516 can perform a CHO based on the time remaining for aircraft 516 to exit relay area S_{relay} 514 (e.g., time tᵣ 518) and/or the time remaining for aircraft 516 to exit the coverage area S_{UE} 504 of UE 502 (e.g., time tᵤ 520). In some examples, aircraft 516 can perform a CHO when tᵣ≤αtᵤ, in which α can correspond to a ratio factor having a value from 0 to 1.

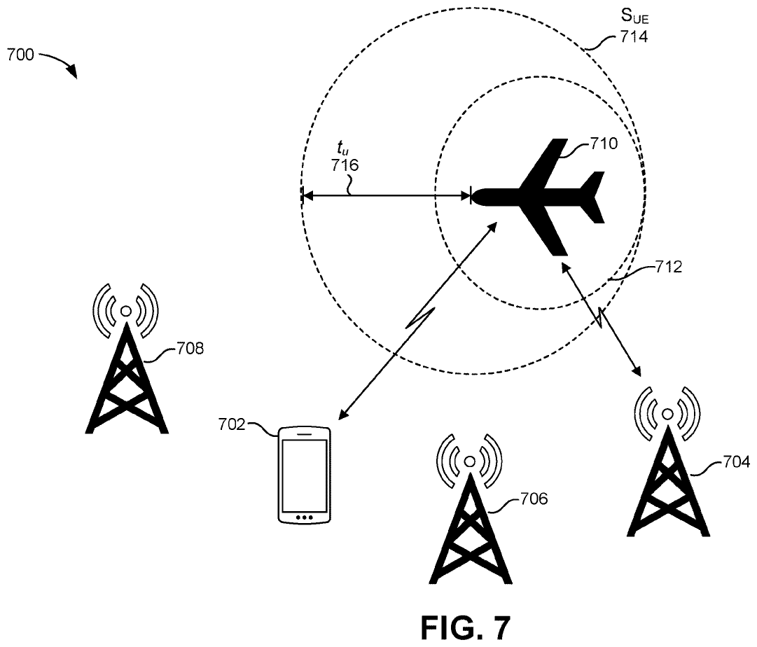

In some examples, aircraft 516 can communicate with one or more candidate base stations (e.g., base station 530 and/or base station 532) to select and/or configure a respective candidate base station to perform a CHO for UE 502. In some cases, aircraft 516 may initiate a CHO based on a handover trigger. In some aspects, a handover trigger can include a location trigger, an RSRP trigger, a time trigger, and/or any other suitable trigger parameter. For example, aircraft 516 may select base station 530 to perform a CHO from base station 508 based on a distance trigger (e.g., distance from aircraft 516 to base station 530 is less than distance from aircraft 516 to base station 508). Further details regarding CHOs are discussed in connection with FIG. 7.

FIG. 6 is a diagram illustrating an example wireless communications system 600 for performing relay aircraft switching. In some aspects, system 600 can include UE 602, base station 604, aircraft 606, aircraft 612, and aircraft 618. As noted with respect to FIG. 5, a UE (e.g., UE 602) may correspond to UEs 104 and a base station (e.g., base station 604) may correspond to base stations 102 and/or to components of a disaggregated base station (e.g., CU 310, DU 330, and/or RU 340).

In some examples, aircraft 606 may be configured as an aircraft relay that can relay data between UE 602 and base station 604. In some aspects, aircraft 606 may be configured to relay data between UE 602 and base station 604 while aircraft 606 is located within relay area 608. In some examples, relay area 608 may correspond to a geographic area in which aircraft 606 can communicate with UE 602 and base station 604.

In some aspects, aircraft 606 may be configured to perform relay aircraft switching by selecting and/or configuring a different candidate aircraft to perform data relaying between UE 602 and base station 604. In some cases, relay aircraft switching can be performed in anticipation of the current relay aircraft (e.g., aircraft 606) leaving relay area 608. For example, aircraft 606 can determine a time remaining (e.g., time tᵣ 610) for aircraft 606 to exit relay area 608. In some examples, aircraft 606 can communicate with one or more candidate aircrafts (e.g., aircraft 612 and/or aircraft 616) to select and/or configure a respective candidate aircraft to perform data relaying between UE 602 and base station 604.

In some examples, aircraft 606 may send (e.g., transmit or broadcast) location data associated with UE 602 and/or base station 604 to aircraft 612 and/or aircraft 616. In some cases, the location data may be sent by aircraft 606 periodically or asynchronously (e.g., aircraft 606 may send location data when tᵣ 610 is less than or equal to a threshold value). In some aspects, aircraft 612 and/or aircraft 616 may obtain location data associated with UE 602 and/or base station 604 from another aircraft, a server, and/or a base station.

In some cases, aircraft 612 and/or aircraft 616 may use location data associated with UE 602 and/or base station 604 to determine relay area 608. In some examples, aircraft 612 and/or aircraft 616 may determine relay area 608 based on signal strength data associated with UE 602 and/or base station 604. In some aspects, aircraft 612 can determine (e.g., based on speed, route, heading, etc.) a time remaining (e.g., time tₑ₁ 614) for aircraft 612 to enter relay area 608. In some cases, aircraft 612 can determine a time duration (e.g., time t_{d1} 620) that aircraft 612 is expected to remain within relay area 608 (e.g., instead or in addition to a time for aircraft 612 to leave relay area 608). In some examples, aircraft 616 can determine a time remaining (e.g., time tₑ₂ 618) for aircraft 616 to enter relay area 608. In some cases, aircraft 616 can determine a time duration (e.g., time t_{d2} 622) that aircraft 616 is expected to remain within relay area 608 (e.g., instead or in addition to a time for aircraft 616 to leave relay area 608).

In some configurations, aircraft 612 and/or aircraft 616 can send (e.g., transmit) one or more timing parameters to aircraft 606. For example, aircraft 612 can send time tₑ₁ 614 and/or time t_{d1} 620 to aircraft 606. In another example, aircraft 616 can send time tₑ₂ 618 and/or time t_{d2} 622 to aircraft 606. In some aspects, aircraft 606 can select a candidate aircraft (e.g., aircraft 612 or aircraft 616) for relay aircraft switching based on one or more timing parameters. In some aspects, aircraft 606 can select the first candidate aircraft entering relay area 608 for relay aircraft switching. For example, aircraft 606 can select aircraft 612 for relay aircraft switching when tₑ₁ 614 is less than tₑ₂ 618. In some cases, aircraft 606 can select a candidate aircraft with the greatest amount of time within relay area 608. For instance, aircraft 606 can select aircraft 616 for relay aircraft switching when t_{d2} 622 is greater than t_{d1} 620. In some cases, aircraft 606 may calculate tₑ₁ 614, tₑ₂ 618, t_{d2} 622, and/or t_{d1} 620 based one or more parameters received from aircraft 612 and/or aircraft 616 (e.g., location data, speed, route, heading, etc.).

In some aspects, aircraft 606 can determine a start time (e.g., tₙ) for the selected candidate aircraft to commence relaying data between UE 602 and base station 604. In some examples, the start time tₙ can correspond to the time when aircraft 606 exits relay area 608 (e.g., start time can be set based on tᵣ 610). In some instances, the start time tₙ can correspond to the time when the selected candidate aircraft enters relay area 608 (e.g., start time can be set based on tₑ₁ 614 or tₑ₂ 618). In some cases, aircraft 606 may exit relay area 608 prior to the selected candidate aircraft entering relay area 608 (e.g., relays service may be unavailable for some time).

In some examples, aircraft 606 may send a message (e.g., an agree message) to the selected candidate aircraft (e.g., aircraft 612 or aircraft 616) that includes the start time tₙ for the selected candidate aircraft to commence relaying data between UE 602 and base station 604. In some aspects, aircraft 606 may also send a message (e.g., the same or a different message) to UE 602 and/or base station 604 that includes the start time tₙ for the selected candidate aircraft to commence relaying data between UE 602 and base station 604.

In some cases, aircraft 606 may receive an acknowledgement (ACK) from the selected candidate aircraft indicating agreement to commence relaying data between UE 602 and base station 604 at the start time tₙ. In some examples, aircraft 606 may send a message to UE 602 and base station 604 that includes data for switching from the current relay aircraft (e.g., aircraft 606) to the selected candidate aircraft (e.g., aircraft 612 or aircraft 616). In some aspects, the message can include the start time tₙ, identification data for the selected candidate aircraft, a modulation parameter, an encoding parameter, a receive power parameter, and/or any other parameters/data for switching to the selected candidate aircraft. In some cases, the message may indicate that the start time tₙ is after tᵣ 610. In some examples, UE 602 and/or base station 604 may be silent (e.g., inhibit or delay transmissions) during time t to avoid message loss (e.g., tᵣ<t<tₙ).

FIG. 7 is a diagram illustrating an example wireless communications system 700 for performing a conditioned handover (CHO). In some aspects, system 700 can include UE 702, base station 704, base station 706, base station 708, and aircraft 710. As noted with respect to FIG. 5, a UE (e.g., UE 702) may correspond to UEs 104 and a base station (e.g., base stations 704, 706, and/or 708) may correspond to base stations 102 and/or to components of a disaggregated base station (e.g., CU 310, DU 330, and/or RU 340).

In some examples, aircraft 710 may be configured as an aircraft relay that can relay data between UE 702 and base station 704. In some aspects, aircraft 710 may be configured to relay data between UE 702 and base station 704 while aircraft 710 is located within a relay area 712. In some examples, relay area 712 may correspond to a geographic area in which aircraft 710 can communicate with UE 702 and base station 704.

In some aspects, aircraft 710 may be configured to perform a conditioned handover (CHO). In some examples, a CHO can be performed in anticipation of the current relay aircraft (e.g., aircraft 710) leaving the coverage area of base station 704 while remaining within coverage area SUE 714 corresponding to UE 702. In some examples, aircraft 710 can communicate with one or more candidate base stations (e.g., base station 706 and/or base station 708) to select and/or configure a respective candidate base station to perform a CHO for UE 702.

In some cases, aircraft 710 may initiate a CHO based on a handover trigger. In some aspects, a handover trigger can include a location trigger, a reference signal received power (RSRP) trigger, a time trigger, and/or any other suitable trigger parameter. In some examples, a location trigger for CHO can be based on a distance between aircraft 710 and the serving cell (e.g., base station 704). For instance, a CHO may be triggered when the distance between aircraft 710 and base station 704 is greater than a threshold value. In some cases, a location trigger for CHO can be based on a distance between aircraft 710 and a candidate target cell (e.g., base station 706 and/or base station 708). For example, a CHO may be triggered when the distance between aircraft 710 and a candidate target cell (e.g., base station 706 or base station 708) is less than a threshold value.

In some aspects, the reference location used to determine distance from aircraft 710 may correspond to the center of a serving cell and/or a candidate target cell. In some cases, the reference location used to determine distance from aircraft 710 may correspond to the center of a beam or beams. In some examples, a CHO may be initiated when aircraft 710 is within a CHO trigger area. In some configurations, the CHO trigger area may correspond to a circle, an ellipse, a polygon, and/or any other suitable shape that may include a reference point for a serving cell and/or a reference point for one or more candidate target cells.

In some cases, an RSRP trigger for CHO can be based on the RSRP of the current serving cell (e.g., base station 704) and/or the RSRP of one or more candidate target cells (e.g., base station 706 and/or base station 708). For example, a CHO may be triggered when the RSRP associated with base station 704 is less than the RSRP associated with a candidate target cell (e.g., base station 706 or base station 708). In another example, a CHO may be triggered based on a threshold RSRP measurement corresponding to a candidate target cell (e.g., base station 706 or base station 708). In some aspects, aircraft 710 may select a candidate serving cell having a highest RSRP. For instance, aircraft 710 may measure the RSRP associated with base station 706 and base station 708 and select the base station having the higher RSRP measurement for performing a CHO.

In some aspects, a time trigger for CHO can be based on a timer, a coordinated universal time (UTC) parameter, a time range, and/or any other suitable timing parameter. For example, a CHO can be initiated when αtᵤ≥tᵣ, where tᵣ corresponds to a time remaining for aircraft 710 to exit relay area 712; tᵤ correspond to a time remaining for aircraft 710 to exit S_{UE} 714 (e.g., tᵤ 716); and a corresponds to a ratio factor having a value of 0 to 1. In another example, a CHO can be initiated when aircraft 710 is withing a threshold time of exiting a coverage area associated with base station 704 and/or when aircraft 710 is within a threshold time of entering a coverage are associated with a candidate target cell (e.g., base station 706 or base station 708).

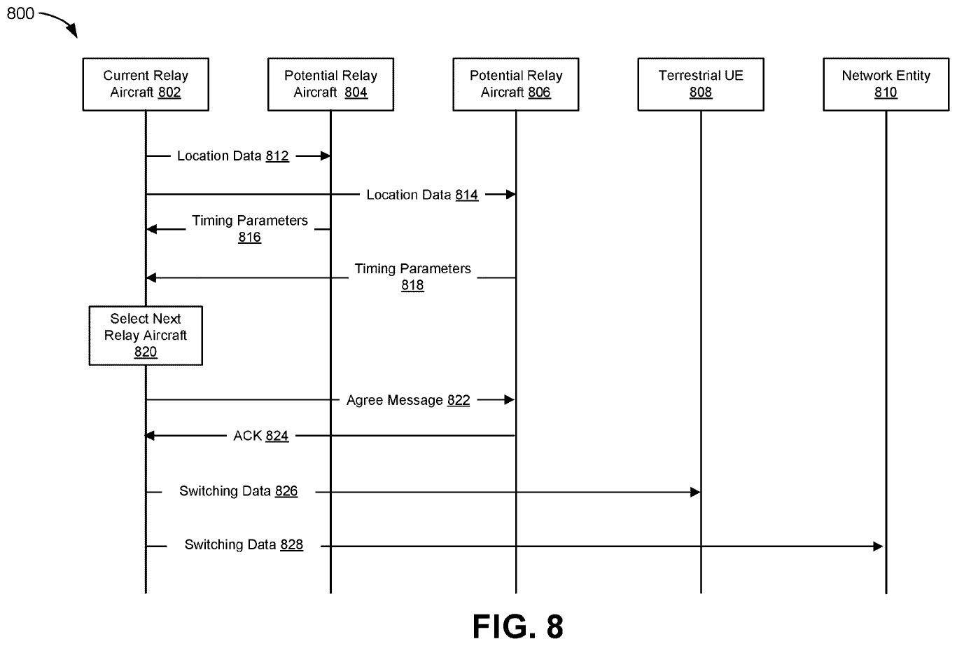

FIG. 8 is a sequence diagram illustrating an example of a sequence 800 for performing relay aircraft switching. The sequence 800 may be performed by current relay aircraft 802, potential relay aircraft 804, potential relay aircraft 806, terrestrial UE 808, and network entity 810. In some aspects, current relay aircraft 802 can be configured to relay data between terrestrial UE 808 and network entity 810.

At action 812, current relay aircraft 802 can send location data corresponding to terrestrial UE 808 and/or network entity 810 to potential relay aircraft 804. At action 814, current relay aircraft 802 can send location data corresponding to terrestrial UE 808 and/or network entity 810 to potential relay aircraft 806. At action 816, potential relay aircraft 804 can send one or more timing parameters to current relay aircraft 802. At action 818, potential relay aircraft 806 can send one or more timing parameters to current relay aircraft 802.

In some aspects, the one or more timing parameters can include a time remaining for a respective potential relay aircraft to enter a relay area in which the potential relay aircraft can relay data between terrestrial UE 808 and network entity 810. In some cases, the one or more timing parameters can include a time remaining to exit a relay area in which the potential relay aircraft can relay data between terrestrial UE 808 and network entity 810. In some aspects, the one or more timing parameters can include a time duration for a respective potential relay aircraft to remain within a relay area in which the potential relay aircraft can relay data between terrestrial UE 808 and network entity 810.

At action 820, current relay aircraft 802 can select the next relay aircraft from among potential relay aircraft 804 and potential relay aircraft 806. In some aspects, current relay aircraft 802 may select the next relay aircraft based on a time for entering the relay area (e.g., current relay aircraft 802 can select the potential relay aircraft that will enter the relay area first). In some cases, current relay aircraft 802 may select the next relay aircraft based on a time duration within the relay area (e.g., current relay aircraft 802 can select the potential relay aircraft that will have the longest time duration within the relay area).

At action 822, current relay aircraft 802 can send an agree message to the potential relay aircraft 806 (e.g., the selected next aircraft). In some cases, the agree message can include the start time for potential relay aircraft 806 to commence relaying data between terrestrial UE 808 and network entity 810. At action 824, potential relay aircraft 806 can send an acknowledgment (ACK) message to current relay aircraft 802. At action 826, current relay aircraft 802 can send a message that includes aircraft relay switching data to terrestrial UE 808. At action 828, current relay aircraft 802 can send a message that includes aircraft relay switching data to network entity 810. In some cases, the aircraft relay switching data can include the start time for potential relay aircraft 806 to commence relaying data between terrestrial UE 808 and network entity 810. In some aspects, the aircraft relay switching data can include one or more parameters for configuring communication between terrestrial UE 808 and potential relay aircraft 802 as well as one or more parameters for configuring communication between network entity 810 and potential relay aircraft 802. In some cases, the one or more parameters can include modulation parameters, encoding parameters, receive power parameters, etc.

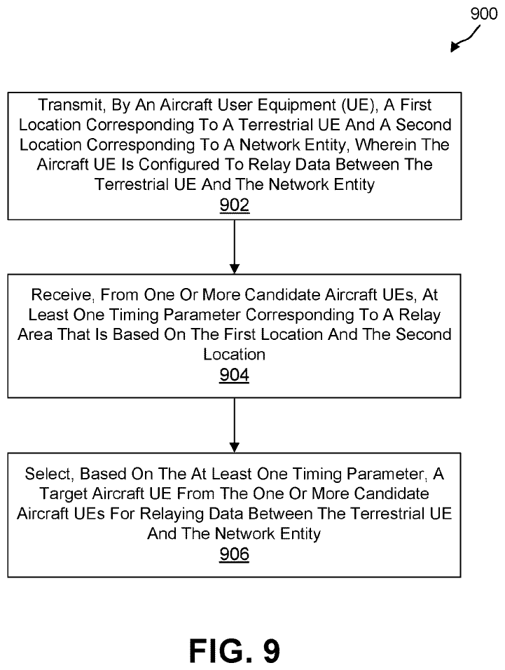

FIG. 9 is a flowchart diagram illustrating an example of a process 900 for performing relay aircraft switching. In some aspects, process 900 may be performed by a current relay aircraft such as aircraft 606. At block 902, the process 900 includes transmitting a first location corresponding to a terrestrial UE and a second location corresponding to a network entity, wherein the aircraft UE is configured to relay data between the terrestrial UE and the network entity. For example, aircraft 606 can be configured to relay data between UE 602 and base station 604. In some aspects, aircraft 606 can transmit a first location corresponding to UE 602 and a second location corresponding to base station 604. In some examples, the transmission can be unicast transmission, a multicast transmission, or a broadcast transmission. In some cases, the transmission can be received by one or more candidate relay aircrafts such as aircraft 612 and/or aircraft 616.

At block 904, the process 900 includes receiving, from one or more candidate aircraft UEs, at least one timing parameter corresponding to a relay area that is based on the first location and the second location. For example, aircraft 606 can receive one or more timing parameters from aircraft 612 and/or aircraft 616. In some aspects, the one or more timing parameters can correspond to a relay area 608 that is based on the location of UE 602 and base station 604. For instance, the relay area 608 can correspond to a geographic area in which an aircraft UE can relay data between UE 602 and base station 604. In some examples, the one or more timing parameters can include tₑ₁ 614, t_{d1} 620, tₑ₂ 618, and/or t_{d2} 622.

At block 906, the process 900 includes selecting, based on the at least one timing parameter, a target aircraft UE from the one or more candidate aircraft UEs for relaying data between the terrestrial UE and the network entity. For instance, aircraft 606 can select aircraft 612 or aircraft 616 as a target aircraft UE for relaying data between UE 602 and base station 604. In some examples, the at least one timing parameter can include at least one of a time to enter the relay area, a time to exit the relay area, and a time duration within the relay area. For example, aircraft 606 may select aircraft 612 or aircraft 616 as the target aircraft UE based on a time to enter relay area 608, a time to exit relay area 608, and a time duration within relay area 608.

In some aspects, selecting the target aircraft UE can include determining, based on the at least one timing parameter, that the target aircraft UE will enter the relay area first among the one or more candidate aircraft UEs. For instance, aircraft 606 may determine that aircraft 612 will enter relay area 608 before aircraft 616 (e.g., tₑ₁ 614 is less than tₑ₂ 618). In some aspects, selecting the target aircraft UE can include determining, based on the at least one timing parameter, that the target aircraft UE will have a longest time duration within the relay area among the one or more candidate aircraft UEs. For example, aircraft 606 may determine that aircraft 616 will have a longest time duration within relay area 608 (e.g., t_{d2} 622 is greater than t_{d1} 620).

In some examples, the process 900 can include transmitting a request to the target aircraft UE for relaying data between the terrestrial UE and the network entity and receiving an acknowledgment to the request from the target aircraft UE. For instance, aircraft 606 can transmit a request to aircraft 612 (e.g., the target aircraft UE) for relaying data between UE 602 and base station 604. In some cases, aircraft 606 may receive an acknowledgment to the request from aircraft 612.

In some aspects, the process 900 may include determining, based on the at least one timing parameter, a start time for the target aircraft UE to begin relaying data between the terrestrial UE and the network entity and transmitting a message to the target aircraft UE that includes the start time. For instance, aircraft 606 may determine a start time for aircraft 612 to begin relaying data between UE 602 and base station 604. In some cases, aircraft 606 can transmit a message to aircraft 612 that includes the start time. In some aspects, the message can include an end time for the aircraft UE to stop relaying data between the terrestrial UE and the network entity. For example, the message can include the time at which aircraft 606 will stop relaying data between UE 602 and base station 604. In some instance, the message can include at least one of a modulation parameter, an encoding parameter, and a receive power parameter.

In some cases, the process 900 can include determining that a start time for the target aircraft UE to begin relaying data between the terrestrial UE and the network entity is after an end time corresponding to the aircraft UE exiting the relay area and transmitting a message to the terrestrial UE and the network entity that includes the start time and the end time. For example, aircraft 606 can determine that the start time for aircraft 612 to begin relaying data between UE 602 and base station 604 is after the end time corresponding to aircraft 606 exiting relay area 608. In some cases, aircraft 606 can send a message to UE 602 and/or base station 604 that includes the start time and the end time (e.g., UE 602 and base station 604 can be configured to delay transmission until the start time).

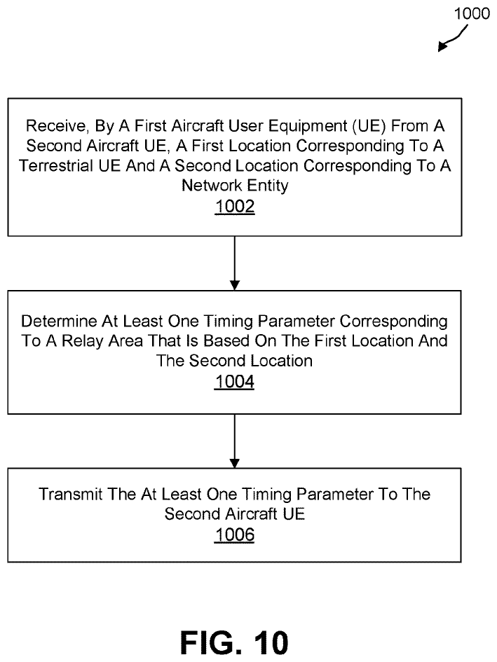

FIG. 10 is a flowchart diagram illustrating an example of a process 1000 for performing relay aircraft switching. In some aspects, process 900 may be performed by a candidate relay aircraft such as aircraft 612 or aircraft 616. At block 1002, the process 1000 includes receiving, by a first aircraft user equipment (UE) from a second aircraft UE, a first location corresponding to a terrestrial UE and a second location corresponding to a network entity. For example, aircraft 612 can receive from aircraft 606 a first location corresponding to UE 602 and a second location corresponding to base station 604.

At block 1004, the process 1000 includes determining at least one timing parameter corresponding to a relay area that is based on the first location and the second location. For instance, aircraft 612 can determine at least one timing parameter corresponding a relay area (e.g., relay area 608) that is based on the location of UE 602 and the location of base station 604. In some cases, the relay area can correspond to a geographic area in which an aircraft may relay data between UE 602 and base station 604. In some examples, the at least one timing parameter can include at least one of a time to enter the relay area, a time to exit the relay area, and a time duration within the relay area. For example, aircraft 612 may determine a time to enter relay area 608 (e.g., tₑ₁ 614), a time duration within relay area 608 (e.g., t_{d1} 620), and/or a time to exit relay area 608.

At block 1006, the process 1000 includes transmitting the at least one timing parameter to the second aircraft UE. For example, aircraft 612 can transmit the at least one timing parameter associated with relay area 608 to aircraft 606. In some aspects, the process 1000 may include receiving a request from the second aircraft UE for relaying data between the terrestrial UE and the network entity and transmitting an acknowledgment to the request to the second aircraft UE. For instance, aircraft 612 may receive a request from aircraft 606 for relaying data between UE 602 and base station 604. In some aspects, aircraft 612 can transmit an acknowledgment to aircraft 606 in response to the request.

In some cases, the request can include a start time for the first aircraft UE to begin relaying data between the terrestrial UE and the network entity. For example, the request received from aircraft 606 can include a start time for aircraft 612 to begin relaying data between UE 602 and base station 604. In some aspects, the request can include an end time for the second aircraft UE to stop relaying data between the terrestrial UE and the network entity. For instance, the request received from aircraft 606 can include an end time at which aircraft 606 will stop relaying data between UE 602 and base station 604. In some examples, the request can include at least one of a modulation parameter, an encoding parameter, and a receive power parameter. For example, the request from aircraft 606 can include parameters that aircraft 612 can use to establish communication with UE 602 and/or base station 604 (e.g., modulation parameters, encoding parameters, receive power parameters, etc.).

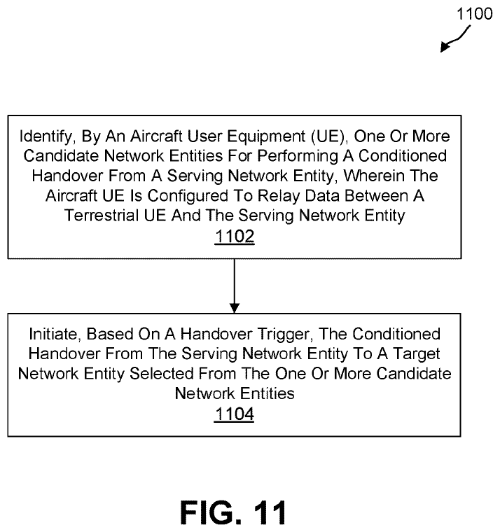

FIG. 11 is a flowchart diagram illustrating an example of a process 1100 for performing a conditioned handover (CHO). In some aspects, process 1100 may be performed by a serving relay aircraft such as aircraft 710. At block 1102, the process 1100 includes identifying, by the aircraft UE, one or more candidate network entities for performing a conditioned handover from a serving network entity, wherein the aircraft UE is configured to relay data between a terrestrial UE and the serving network entity. For example, aircraft 710 can identify base station 706 and base station 708 as candidate network entities for performing a conditioned handover from serving network entity (e.g., base station 704). In some aspects, aircraft 710 can be configured to relay data between UE 702 and base station 704.

At block 1104, the process 1100 includes initiating, based on a handover trigger, the conditioned handover from the serving network entity to a target network entity selected from the one or more candidate network entities. For instance, aircraft 710 can initiate a conditioned handover from base station 704 to a target network entity (e.g., base station 706 or base station 708) based on a handover trigger. In some examples, the handover trigger includes at least one of a location trigger, a reference signal received power (RSRP) trigger, and a time trigger.

In some cases, the location trigger can be based on a distance between the aircraft UE and the serving network entity. For example, the location trigger can be based on a distance between aircraft 710 and base station 704. In some instances, the CHO may be initiated when the distance between aircraft 710 and base station 704 is greater than a threshold value. In some aspects, the location trigger is based on a distance between the aircraft UE and the target network entity. For example, the CHO may be initiated based on a distance between aircraft 710 and base station 706 or base station 708.

In some examples, the process 1100 can include determining that a first RSRP measurement corresponding to the target network entity is greater than a second RSRP measurement corresponding to the serving network entity, wherein the handover trigger corresponds to the RSRP trigger. For example, aircraft 710 can determine that the RSRP associated with base station 706 (e.g., target network entity) is greater than the RSRP associated with base station 704 (e.g., serving network entity).

In some cases, the process 1100 can include determining that a first RSRP measurement corresponding to the target network entity is a highest RSRP measurement among the one or more candidate network entities, wherein the handover trigger corresponds to the RSRP trigger. For instance, aircraft 710 can determine that the RSRP associated with base station 706 is highest among the candidate network entities (e.g., higher than the RSRP associated with base station 708).

In some examples, the process 1100 can include relaying data between the terrestrial UE and the target network entity. For example, aircraft 710 can be configured to perform a CHO and relay data among UE 702 and base station 706 (e.g., the target network entity).

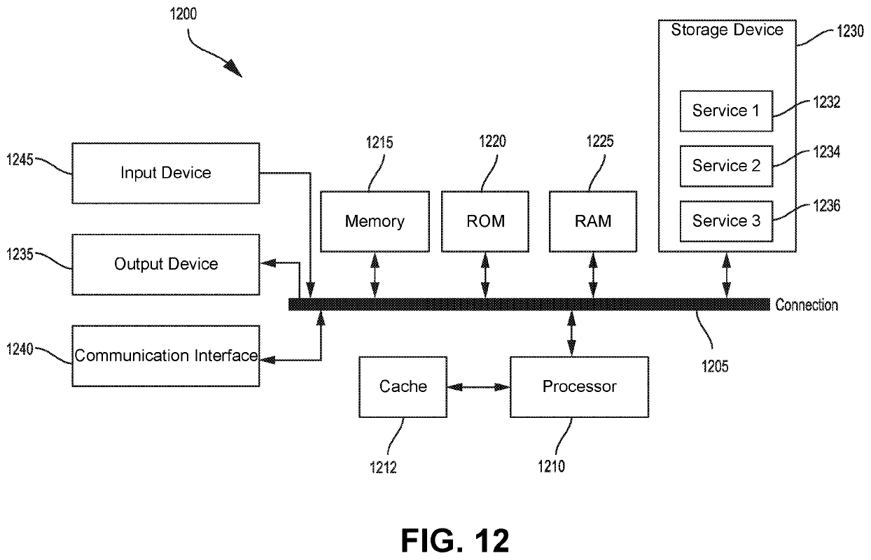

In some examples, the processes described herein (e.g., process 900, process 1000, process 1100, and/or other process described herein) may be performed by a computing device or apparatus (e.g., a UE, a network entity, etc.). In one example, the processes 900, 1000, and 1100 may be performed by a wireless communication device, such as a UE (e.g., the UE 407 of FIG. 4, the aircraft UE 516 of FIG. 5, a mobile device, and/or other UE or device). In another example, the process 900, the process 1000, and/or the process 1100 may be performed by a computing device with the computing system 1200 shown in FIG. 12. For instance, a wireless communication device (e.g., the UE 407 of FIG. 4, the aircraft UE 516, and/or other UE or device) with the computing architecture shown in FIG. 12 may include the components of the UE and may implement the operations of FIG. 9, FIG. 10, and/or FIG. 11.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes 900, 1000, and 1100 are illustrated as logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes 900, 1000, 1100, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some aspects, computing system 1200 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1212 of high-speed memory connected directly with, in close proximity to, or integrated as part of processor 1210.

Processor 1210 may include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some aspects, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative Aspects of the disclosure include:

Aspect 1. A method for wireless communications performed at an aircraft user equipment (UE), comprising: transmitting a first location corresponding to a terrestrial UE and a second location corresponding to a network entity, wherein the aircraft UE is configured to relay data between the terrestrial UE and the network entity; receiving, from one or more candidate aircraft UEs, at least one timing parameter corresponding to a relay area that is based on the first location and the second location; and selecting, based on the at least one timing parameter, a target aircraft UE from the one or more candidate aircraft UEs for relaying data between the terrestrial UE and the network entity.

Aspect 2. The method of Aspect 1, wherein the selecting of the target aircraft UE further comprises: determining, based on the at least one timing parameter, that the target aircraft UE will enter the relay area first among the one or more candidate aircraft UEs.

Aspect 3. The method of any of Aspects 1 to 2, wherein the selecting of the target aircraft UE further comprises: determining, based on the at least one timing parameter, that the target aircraft UE will have a longest time duration within the relay area among the one or more candidate aircraft UEs.

Aspect 4. The method of any of Aspects 1 to 3, wherein the at least one timing parameter includes at least one of a time to enter the relay area, a time to exit the relay area, and a time duration within the relay area.

Aspect 5. The method of any of Aspects 1 to 4, further comprising: transmitting a request to the target aircraft UE for relaying data between the terrestrial UE and the network entity; and receiving an acknowledgment to the request from the target aircraft UE.

Aspect 6. The method of any of Aspects 1 to 5, further comprising: determining, based on the at least one timing parameter, a start time for the target aircraft UE to begin relaying data between the terrestrial UE and the network entity; and transmitting a message to the target aircraft UE that includes the start time.

Aspect 7. The method of Aspect 6, wherein the message includes an end time for the aircraft UE to stop relaying data between the terrestrial UE and the network entity.

Aspect 8. The method of any of Aspects 6 to 7, wherein the message includes at least one of a modulation parameter, an encoding parameter, and a receive power parameter.

Aspect 9. The method of any of Aspects 1 to 8, further comprising: determining that a start time for the target aircraft UE to begin relaying data between the terrestrial UE and the network entity is after an end time corresponding to the aircraft UE exiting the relay area; and transmitting a message to the terrestrial UE and the network entity that includes the start time and the end time.

Aspect 10. An apparatus for wireless communications, comprising: at least one memory; and at least one processor coupled to the at least one memory, wherein the at least one processor is configured to perform operations in accordance with any one of Aspects 1-9.

Aspect 11. An apparatus for wireless communications, comprising means for performing operations in accordance with any one of Aspects 1 to 9.

Aspect 12. A non-transitory computer-readable medium comprising instructions that, when executed by an apparatus, cause the apparatus to perform operations in accordance with any one of Aspects 1 to 9.

Aspect 13. A method for wireless communications performed at a first aircraft user equipment (UE), comprising: receiving, from a second aircraft UE, a first location corresponding to a terrestrial UE and a second location corresponding to a network entity; determining at least one timing parameter corresponding to a relay area that is based on the first location and the second location; and transmitting the at least one timing parameter to the second aircraft UE.

Aspect 14. The method of Aspect 13, wherein the at least one timing parameter includes at least one of a time to enter the relay area, a time to exit the relay area, and a time duration within the relay area.

Aspect 15. The method of any of Aspects 13 to 14, further comprising: receiving a request from the second aircraft UE for relaying data between the terrestrial UE and the network entity; and transmitting an acknowledgment to the request to the second aircraft UE.

Aspect 16. The method of Aspect 15, wherein the request includes a start time for the first aircraft UE to begin relaying data between the terrestrial UE and the network entity.

Aspect 17. The method of any of Aspects 15 to 16, wherein the request includes an end time for the second aircraft UE to stop relaying data between the terrestrial UE and the network entity.

Aspect 18. The method of any of Aspects 15 to 17, wherein the request includes at least one of a modulation parameter, an encoding parameter, and a receive power parameter.

Aspect 19. An apparatus for wireless communications, comprising: at least one memory; and at least one processor coupled to the at least one memory, wherein the at least one processor is configured to perform operations in accordance with any one of Aspects 13-18.

Aspect 20. An apparatus for wireless communications, comprising means for performing operations in accordance with any one of Aspects 13 to 18.

Aspect 21. A non-transitory computer-readable medium comprising instructions that, when executed by an apparatus, cause the apparatus to perform operations in accordance with any one of Aspects 13 to 18.

Aspect 22. A method for wireless communications performed at an aircraft user equipment (UE), comprising: identifying, by the aircraft UE, one or more candidate network entities for performing a conditioned handover from a serving network entity, wherein the aircraft UE is configured to relay data between a terrestrial UE and the serving network entity; and initiating, based on a handover trigger, the conditioned handover from the serving network entity to a target network entity selected from the one or more candidate network entities.

Aspect 23. The method of Aspect 22, wherein the handover trigger includes at least one of a location trigger, a reference signal received power (RSRP) trigger, and a time trigger.

Aspect 24. The method of Aspect 23, wherein the location trigger is based on a distance between the aircraft UE and the first network entity.

Aspect 25. The method of Aspect 23, wherein the location trigger is based on a distance between the aircraft UE and the target network entity.

Aspect 26. The method of any of Aspects 22 to 25, further comprising: determining that a first RSRP measurement corresponding to the target network entity is greater than a second RSRP measurement corresponding to the serving network entity, wherein the handover trigger corresponds to the RSRP trigger.

Aspect 27. The method of any of Aspects 22 to 26, further comprising: determining that a first RSRP measurement corresponding to the target network entity is a highest RSRP measurement among the one or more candidate network entities, wherein the handover trigger corresponds to the RSRP trigger.

Aspect 28. The method of any of Aspects 22 to 27, further comprising: relaying data between the terrestrial UE to the target network entity.

Aspect 29. An apparatus for wireless communications, comprising: at least one memory; and at least one processor coupled to the at least one memory, wherein the at least one processor is configured to perform operations in accordance with any one of Aspects 22-28.

Aspect 30. An apparatus for wireless communications, comprising means for performing operations in accordance with any one of Aspects 22 to 28.

Aspect 31. A non-transitory computer-readable medium comprising instructions that, when executed by an apparatus, cause the apparatus to perform operations in accordance with any one of Aspects 22 to 28.

What is claimed is:

1. An apparatus for wireless communications, comprising:
at least one memory comprising instructions; and
at least one processor configured to execute the instructions and cause the apparatus to:
transmit a first location corresponding to a terrestrial UE and a second location corresponding to a network entity, wherein the apparatus is configured to relay data between the terrestrial UE and the network entity;
receive, from one or more candidate aircraft UEs, at least one timing parameter corresponding to a relay area that is based on the first location and the second location; and
select, based on the at least one timing parameter, a target aircraft UE from the one or more candidate aircraft UEs for relaying data between the terrestrial UE and the network entity.

2. The apparatus of claim 1, wherein to select the target aircraft UE the at least one processor is further configured to cause the apparatus to:
determine, based on the at least one timing parameter, that the target aircraft UE will enter the relay area first among the one or more candidate aircraft UEs.

3. The apparatus of claim 1, wherein to select the target aircraft UE the at least one processor is further configured to cause the apparatus to:
determine, based on the at least one timing parameter, that the target aircraft UE will have a longest time duration within the relay area among the one or more candidate aircraft UEs.

4. The apparatus of claim 1, wherein the at least one timing parameter includes at least one of a time to enter the relay area, a time to exit the relay area, and a time duration within the relay area.

5. The apparatus of claim 1, wherein the at least one processor is further configured to cause the apparatus to:
transmit a request to the target aircraft UE for relaying data between the terrestrial UE and the network entity; and
receive an acknowledgment to the request from the target aircraft UE.

6. The apparatus of claim 1, wherein the at least one processor is further configured to cause the apparatus to:
determine, based on the at least one timing parameter, a start time for the target aircraft UE to begin relaying data between the terrestrial UE and the network entity; and
transmit a message to the target aircraft UE that includes the start time.

7. The apparatus of claim 6, wherein the message includes an end time for the apparatus to stop relaying data between the terrestrial UE and the network entity.

8. The apparatus of claim 6, wherein the message includes at least one of a modulation parameter, an encoding parameter, and a receive power parameter.

9. The apparatus of claim 1, wherein the at least one processor is further configured to cause the apparatus to:
determine that a start time for the target aircraft UE to begin relaying data between the terrestrial UE and the network entity is after an end time corresponding to the apparatus exiting the relay area; and
transmit a message to the terrestrial UE and the network entity that includes the start time and the end time.

10. A method for wireless communications performed at an aircraft user equipment (UE), comprising:
transmitting a first location corresponding to a terrestrial UE and a second location corresponding to a network entity, wherein the aircraft UE is configured to relay data between the terrestrial UE and the network entity;
receiving, from one or more candidate aircraft UEs, at least one timing parameter corresponding to a relay area that is based on the first location and the second location; and
selecting, based on the at least one timing parameter, a target aircraft UE from the one or more candidate aircraft UEs for relaying data between the terrestrial UE and the network entity.

11. The method of claim 10, wherein the selecting of the target aircraft UE further comprises:
determining, based on the at least one timing parameter, that the target aircraft UE will enter the relay area first among the one or more candidate aircraft UEs.

12. The method of claim 10, wherein the selecting of the target aircraft UE further comprises:
determining, based on the at least one timing parameter, that the target aircraft UE will have a longest time duration within the relay area among the one or more candidate aircraft UEs.

13. The method of claim 10, wherein the at least one timing parameter includes at least one of a time to enter the relay area, a time to exit the relay area, and a time duration within the relay area.

14. The method of claim 10, further comprising:
transmitting a request to the target aircraft UE for relaying data between the terrestrial UE and the network entity; and
receiving an acknowledgment to the request from the target aircraft UE.

15. The method of claim 10, further comprising:
determining, based on the at least one timing parameter, a start time for the target aircraft UE to begin relaying data between the terrestrial UE and the network entity; and
transmitting a message to the target aircraft UE that includes the start time.

16. The method of claim 15, wherein the message includes an end time for the aircraft UE to stop relaying data between the terrestrial UE and the network entity.

17. The method of claim 15, wherein the message includes at least one of a modulation parameter, an encoding parameter, and a receive power parameter.

18. The method of claim 10, further comprising:
determining that a start time for the target aircraft UE to begin relaying data between the terrestrial UE and the network entity is after an end time corresponding to the aircraft UE exiting the relay area; and
transmitting a message to the terrestrial UE and the network entity that includes the start time and the end time.

19. An apparatus for wireless communications, comprising:
at least one memory comprising instructions; and
at least one processor configured to execute the instructions and cause the apparatus to:
receive, from an aircraft UE, a first location corresponding to a terrestrial UE and a second location corresponding to a network entity;
determine at least one timing parameter corresponding to a relay area that is based on the first location and the second location; and
transmit the at least one timing parameter to the aircraft UE.

20. The apparatus of claim 19, wherein the at least one timing parameter includes at least one of a time to enter the relay area, a time to exit the relay area, and a time duration within the relay area.

21. The apparatus of claim 19, wherein the at least one processor is further configured to cause the apparatus to:
receive a request from the aircraft UE for relaying data between the terrestrial UE and the network entity; and
transmit an acknowledgment to the request to the aircraft UE.

22. The apparatus of claim 21, wherein the request includes a start time for the apparatus to begin relaying data between the terrestrial UE and the network entity.

23. The apparatus of claim 21, wherein the request includes an end time for the aircraft UE to stop relaying data between the terrestrial UE and the network entity.

24. The apparatus of claim 21, wherein the request includes at least one of a modulation parameter, an encoding parameter, and a receive power parameter.

25. An apparatus for wireless communications, comprising:
at least one memory comprising instructions; and
at least one processor configured to execute the instructions and cause the apparatus to:
identify one or more candidate network entities for performing a conditioned handover from a serving network entity, wherein the apparatus is configured to relay data between a terrestrial UE and the serving network entity; and
initiate, based on a handover trigger, the conditioned handover from the serving network entity to a target network entity selected from the one or more candidate network entities.

26. The apparatus of claim 25, wherein the handover trigger includes at least one of a location trigger, a reference signal received power (RSRP) trigger, and a time trigger.

27. The apparatus of claim 26, wherein the location trigger is based on a distance between the apparatus and the serving network entity.

28. The apparatus of claim 26, wherein the location trigger is based on a distance between the apparatus and the target network entity.

29. The apparatus of claim 26, wherein the at least one processor is further configured to cause the apparatus to:
determine that a first RSRP measurement corresponding to the target network entity is greater than a second RSRP measurement corresponding to the serving network entity, wherein the handover trigger corresponds to the RSRP trigger.

30. The apparatus of claim 26, wherein the at least one processor is further configured to cause the apparatus to:
determine that a first RSRP measurement corresponding to the target network entity is a highest RSRP measurement among the one or more candidate network entities, wherein the handover trigger corresponds to the RSRP trigger.
